(19) United States
(12) Patent Application Publication
(10) Pub. No.: US 2004/0036461 A1
(43) Pub. Date: Feb. 26, 2004

(54) Switchgear and relaying configuration

(76) Inventor: Peter Edward Sutherland, Voorheesville, NY (US)

Correspondence Address: John S. Beulick, Armstrong Teasdale LLP, One Metropolitan Sq., Suite 2600, St. Louis, MO, 63102, US

(21) Appl. No.: 10/225,955

(22) Filed: Aug. 22, 2002

(51) Int. Cl. H01F 17/00

(52) U.S. Cl. 323/355

(57) ABSTRACT

A method for operating an electrical apparatus includes mounting an instrument transformer proximate a load current carrying conductor, wherein the instrument transformer includes a current transformer for supplying an analog input signal proportional to a load current, the current transformer is coupled to a relay front-end module that includes a current-to-voltage converter circuit and is configured to couple to a remote protection module, converting the analog input signal to a digital input signal, transmitting the digital input signal to the remote protection module; and activating contacts to operate the electrical apparatus based on the digital input signals.

### BACKGROUND OF THE INVENTION

This invention relates generally to electrical switchgear and more particularly, to electrical and electronic instruments for monitoring the performance of electrical switchgear.

In an industrial power distribution system, power generated by a power generation company may be supplied to an industrial or commercial facility wherein the power is distributed around the industrial or commercial facility to various equipment such as, for example, motors, welding machinery, computers, heaters, lighting, and other electrical equipment. At least some known, power distribution systems include switchgear which facilitates dividing the power into branch circuits which supply power to various portions of the industrial facility. Circuit breakers are provided in each branch circuit to facilitate protecting equipment within the branch circuit. Additionally, circuit breakers in each branch circuit can facilitate minimizing equipment failures since specific loads may be energized or deenergized without affecting other loads, thus creating increased efficiencies, and reduced operating and manufacturing costs. A similar selecting tripping situation applies within electric utility system transmission and distribution substations, although the switching operations used may be more complex.

At least some known circuit breakers utilize electronic circuitry to monitor a level of current passing through the branch circuits, and to trip the breaker when the current exceeds a pre-defined value. Electronic circuit breakers are adjustable depending on the particular application, and may include a protection module that is coupled to one or more current sensors. The protection module continuously monitors digitized current values using curves which define permissible time frames in which both low-level and high-level overcurrent conditions may exist. For example, if an overcurrent condition has been maintained for longer than its permissible time frame, the breaker is tripped. Accurate current readings may be affected by the measuring instruments themselves. More specifically and for example, current transformer (CT) saturation may cause errors even when low-burden static relays are used.

At least some known circuit breakers use protection modules to monitor and control other types of faults, such as over or under voltage conditions and phase loss or imbalances. Such protection modules also require instrument sensors to translate raw electrical signals into conditioned signals which are usable by breaker protection modules. Accuracy in the measurement of the electrical parameters is important to ensure power design limits are not being exceeded while still maintaining equipment in service during transient conditions. To facilitate improved accuracy, high quality and stable components may be used in the construction of protective instrumentation. However, such components increase production costs. Another technique used is to compensate for known or estimated errors in the measurement ability of an instrument system. Once errors are quantified a countervailing circuit is introduced to balance the errors out of the system. However, this technique is often difficult to maintain and may lead to greater errors or less predictable errors being introduced into the system.

### BRIEF DESCRIPTION OF THE INVENTION

In one aspect, a method for operating an electrical apparatus is provided. The method includes mounting an instrument transformer proximate a load current carrying conductor, wherein the instrument transformer includes a current transformer for supplying an analog input signal proportional to a load current, the current transformer is coupled to a relay front-end module that includes a current-to-voltage converter circuit and is configured to couple to a remote protection module, converting the analog input signal to a digital input signal, transmitting the digital input signal to the remote protection module; and activating contacts to operate the electrical apparatus based on the digital input signals.

In another aspect, an instrument transformer is provided. The instrument transformer includes a current transformer for supplying an analog input signal proportional to a load current, the current transformer is coupled to a relay front-end module, the relay front-end module including a current-to-voltage converter circuit and the relay front-end module is configured to couple to a remote protection module.

In still another aspect, an electrical apparatus for connecting a load to an electrical power source is provided. The electrical apparatus includes separable contacts selectively connecting the load to the power source when closed and disconnecting the load from the power source when open and an instrument transformer including a current transformer for supplying an input signal proportional to a load current, the current transformer coupled to a relay front-end module, the relay front-end module including a current-to-voltage converter circuit, the relay front-end module configured to couple to a remote protection module.

### BRIEF DESCRIPTION OF THE DRAWINGS

FIG. 1 is a schematic illustration of a known current transformer arrangement.

FIG. 2 is a schematic illustration of an exemplary embodiment of the present invention.

FIG. 3 is a schematic illustration of an alternative embodiment of the present invention.

FIG. 4 illustrates a block diagram of an instrument transformer of the present invention.

### DETAILED DESCRIPTION OF THE INVENTION

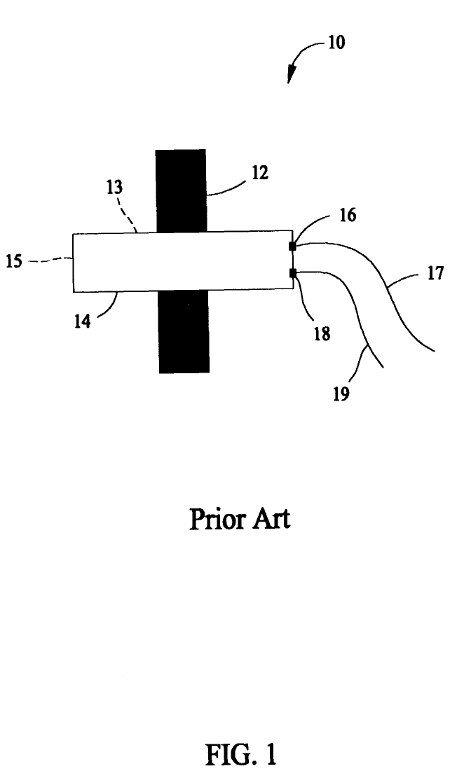

FIG. 1 is a schematic illustration of a known instrument transformer 10 arrangement. Busbar 12 is a primary conductor in an alternating current (AC) switchgear panel (not shown) and is conducted through a toroidal core 13 of a current transformer 14 such that busbar 12 and a plurality of electrical windings 15 within current transformer 14 are magnetically coupled Electrical terminations 16 and 18 couple current transformer 14 to copper conductors 20 and 22 respectively to transmit a signal generated by current transformer 14 to a measuring device (not shown).

In operation, an alternating current flowing in busbar 12 induces a proportional current signal in windings 15 of current transformer 14. The current signal is transmitted via terminations 16 and 18 to conductors 17 and 19 which transmit the current signal to a measuring device.

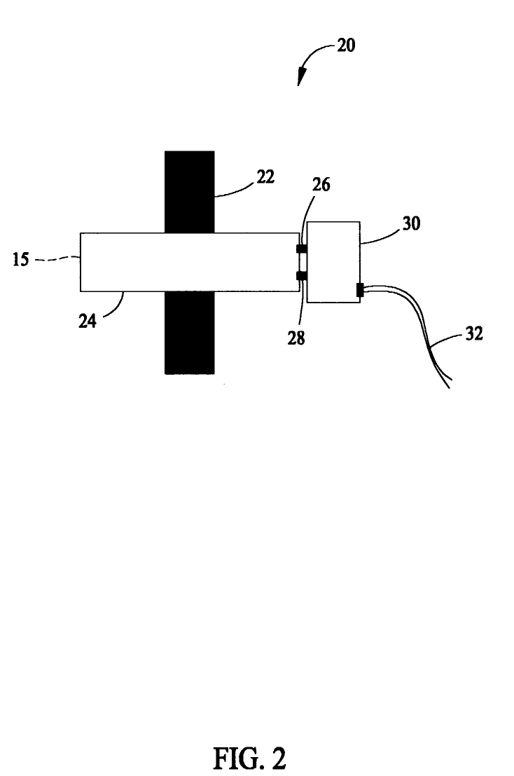

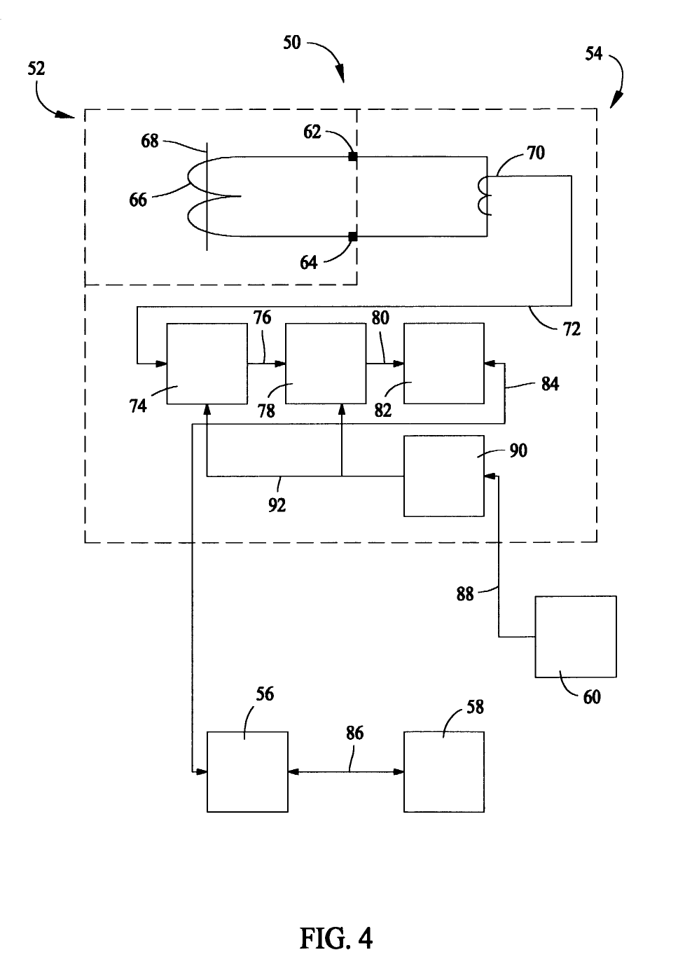

FIG. 2 is a schematic illustration of an instrument transformer arrangement 20. A switchgear busbar 22 is a primary conductor conducted through and magnetically coupled to a current transformer 24. Electrical terminations 26 and 28 couple current transformer 24 to a retrofit relay front end module 30. In the exemplary embodiment, relay front end module 30 is mechanically supported by as well as electrically coupled to, current transformer 24 by terminations 26 and 28. In another embodiment, an auxiliary attachment is used to couple relay front end module 30 to current transformer 24. The details of the relay front end module 30 are discussed below. The output of relay front end module 30 is transmitted through conduit 32 to a relay protection module (shown in FIG. 4). In an alternative embodiment, front end module 30 may be coupled to other switchgear electrical or electronic devices such as, for example, a limit switch, timer, transfer switch, panel control or display.

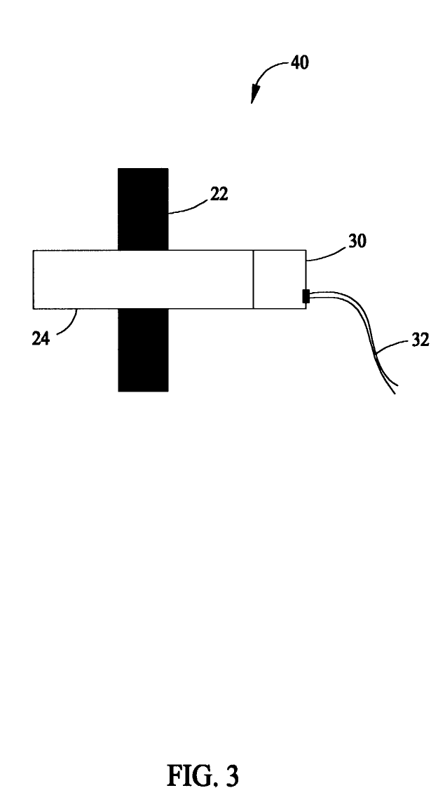

FIG. 3 is a schematic illustration of an alternative embodiment of an instrument transformer arrangement 40. Instrument transformer 40 is similar to instrument transformer 20 (shown in FIG. 2) and components in instrument transformer 40 that are identical to components of instrument transformer 20 are identified in FIG. 3 using the same reference numerals used in FIG. 2. Accordingly, instrument transformer 40 includes switchgear busbar 22 which is a primary conductor conducted through and magnetically coupled to a current transformer 24. Relay front end module 30 is integrally formed with current transformer 24. The details of the relay front end module 30 are discussed below. The output of relay front end module 30 is transmitted through conduit 32 to a relay protection module (shown in FIG. 4). In an alternative embodiment, front end module 30 may be integrally formed and coupled to other switchgear electrical or electronic devices such as, for example, a limit switch, timer, transfer switch, panel control or display.

FIG. 4 illustrates a block diagram of an instrument transformer 50 that may be used within instrument transformer arrangements 20 or 40 (shown in FIGS. 2 and 3 respectively). Instrument transformer 50 includes a current transformer (CT) 52, a relay front end module 54, a protection module 56, a user interface module 58 and a fiber optic power supply module 60. In one embodiment, current transformer 52, is a known CT that is retrofitted to receive relay front end module 54. Terminals 62 and 64 couple relay front end module 54 to current transformer 52. Current transformer 52 includes a toroidal shaped secondary winding 66, through which a primary winding 68 is conducted. In the exemplary embodiment, primary winding 68 is a switchgear busbar or cable. A raw current signal from current transformer 52 is conducted to step down transformer 70 which reduces an amplitude of the raw current signal to a level suitable for processing within relay front end module 54.

An instrument level signal is conducted via conduit 72 to a current to voltage converter 74, wherein the current signal is converted to a proportional voltage signal. The voltage signal is conducted via conduit 76 to an analog to digital (A/D) converter 78 wherein the signal is digitized and transmitted via a conduit 80 to a fiber optic interface 82. Fiber optic interface 82 communicates via fiber optic bus 84 with protection module 56. This communication is bi-directional, such that signal data is transmitted to protection module 56, while limit value and setup data may be transmitted to fiber optic interface 82.

Protection module 56 communicates data to user interface module 58 via conduit 86 and receives commands and limit values from user interface module 58. In one embodiment, user interface module 58 is a thin screen module mounted to a user accessible portion of a switchgear panel exterior. In another embodiment, user interface module 58 is mounted remotely, for example, in a central control room for remote monitoring of a status of instrument transformer 50. User interface module 58 includes a user input portion (not shown), for example, a key pad, touch screen, and communications port or any combination thereof. The communications port may be coupled to a personal computer or another data processing device. User interface module 58 also includes a display for indicating a status of the instrument transformer including, but not limited to, operational status, fault status, self diagnostic results and additional programmable status indications. In one embodiment, bus 86 facilitates communication with a plurality of protection modules 56 and one or more user interface modules 58.

The flexibility of a fiber optic data highway communications path allows many systems to be monitored and controlled from a central location or any number of remote locations. Communications conduits 84 and 86 are not limited to a fiber optic architecture but, may be any of a wide array of standard communications bus architectures including, but not limited to Ethernet, RS-485, or other applicable bus architectures. Communications conduits 84 and 86 may use any of a number of applicable communications protocols including, but not limited to profibus, profibus DP, TCP/IP, or any other applicable communications protocol. Fiber optic power supply module 60, in one embodiment, is located in the switchgear panel proximate user interface module 58. Fiber optic power supply module 60 supplies power via conduit 88 to relay front end module fiber optic components through fiber optic power supply 90 and conduit 92.

The exemplary embodiment has heretofore been described as an instrument transformer with a current transformer as the sensor. Other similar instrument transformers based on other sensors may be incorporated in the same manner. For example, voltage, frequency, temperature, infrared spectrum energy, vibration, flow, interlocks and safety devices can be modularized in similar fashion and incorporated into the monitoring and protection system described herein. In operation, coupling a relay front end module 30 directly to a current transformer 24 reduces the amount of copper connecting wire required to manufacture switchgear. Instead, most of the signal carrying conduit is fiber optic.

The electromagnetic environment within electrical switchgear in the area of the busbars is characterized by high electrical and magnetic field strength and often by the presence of high levels of electrical “noise,” that is, unwanted signals which interfere with instrumentation and measurement. These conditions may severely affect electrical equipment and communications. For this reason, instrument transformer signals in switchgear are at relatively high electrical levels, such as 5 Amperes for current transformer signals and 120 Volts for voltage transformer signals. In addition, electrical shielding is provided between the high voltage compartments and the instrumentation and relaying compartments by means of grounded steel enclosures. Fiber optic communications signals are not affected by this relatively low-frequency electromagnetic environment, and thus are an ideal communications medium for electrical switchgear. Fiber optics are commonly used in the industry for triggering high-voltage thyristors, and for communications with high voltage equipment. This invention describes a new application of fiber optics to electrical switchgear. The electrical module (54 in FIG. 4) should be shielded from electromagnetic interference with means such as a grounded steel container. Alternatively, it may be designed using electronic devices which do not require such shielding.

The invention described here is not limited in terms of its application to instrument transformer circuits. The entire wiring harness assembly of electrical switchgear may be replaced by fiber-optic cables. Each device, such as panel controls and displays, metering, instrumentation and relaying, and all other devices, such as limit switches, timers, transfer switches, and so forth may be connected by a fiber optic network much smaller in size and lower in cost than the copper wire assemblies in present use.

The above described instrument transformer configuration for switchgear is cost-effective and reliable. The instrument transformer includes a sensor coupled to a relay front end module. The sensor includes a current transformer but, may be any number of electrical or process sensors depending on a user's requirements. The relay front end module includes signal conversion and conditioning components and a communications module to receive data and commands and pass data on to a protection module over a fiber optic or other suitable conduit. Mounting the relay front end module to the sensor and using a fiber optic communications bus instead of copper panel wire will reduce a high cost construction component and labor intensive manufacturing step. As a result, a reliable and durable instrument assembly is provided for a switchgear.

While the invention has been described in terms of various specific embodiments, those skilled in the art will recognize that the invention can be practiced with modification within the spirit and scope of the claims.

What is claimed is:

1. A method for operating an electrical apparatus, said method comprising:
mounting an instrument transformer proximate a load current carrying conductor, the instrument transformer includes a current transformer for supplying an analog input signal proportional to a load current, the current transformer coupled to a relay front-end module that includes a current-to-voltage converter circuit and is configured to couple to a remote protection module;
converting the analog input signal to a digital input signal;
transmitting the digital input signal to the remote protection module; and
activating contacts to operate the electrical apparatus based on the digital input signals.

2. A method in accordance with claim 1 wherein mounting an instrument transformer comprises mounting a current transformer including an integrally formed relay front-end module proximate a load current carrying conductor.

3. A method in accordance with claim 1 wherein processing the digital input signal further comprises receiving predetermined limit values from the user interface module.

4. A method in accordance with claim 3 wherein receiving predetermined limit values comprises a breaker protection coordination scheme.

5. A method in accordance with claim 3 wherein processing the digital input signal further comprises receiving protection module calibration data.

6. An instrument transformer comprising a current transformer for supplying an analog input signal proportional to a load current, said current transformer coupled to a relay front-end module, said relay front-end module comprising a current-to-voltage converter circuit, said relay front-end module configured to couple to a remote protection module.

7. An instrument transformer in accordance with claim 6 wherein said relay front-end module further comprises an analog-to-digital (A/D) converter coupled to said current-to-voltage converter circuit.

8. An instrument transformer in accordance with claim 6 wherein said relay front-end module further comprises a step down transformer electrically coupled to a plurality of relay front-end module input terminations extending from said relay front-end module for receiving the analog input signal from said current transformer.

9. An instrument transformer in accordance with claim 7 wherein said front-end module further comprises a fiber optic interface coupled to said A/D converter.

10. An instrument transformer in accordance with claim 6 wherein said relay front-end module further comprises a fiber optic power supply coupled to said current-to-voltage converter and an A/D converter.

11. An instrument transformer in accordance with claim 10 wherein said fiber optic power supply is coupled to a remote fiber optic power supply module.

12. An instrument transformer in accordance with claim 6 wherein said protection module is coupled to a user interface module.

13. An instrument transformer in accordance with claim 6 wherein said user interface module comprises a data display.

14. An instrument transformer in accordance with claim 6 wherein said user interface module comprises a communications port.

15. An instrument transformer in accordance with claim 6 wherein said user interface module comprises an integral keypad.

16. An instrument transformer in accordance with claim 6 wherein said current transformer and relay front-end module are integrally formed.

17. An electrical apparatus for connecting a load to an electrical power source, said apparatus comprising:
separable contacts selectively connecting the load to the power source when closed and disconnecting the load from the power source when open; and
an instrument transformer comprising a current transformer for supplying an input signal proportional to a load current, said current transformer coupled to a relay front-end module, said relay front-end module comprising a current-to-voltage converter circuit, said relay front-end module configured to couple to a remote protection module.

18. An electrical apparatus in accordance with claim 17 wherein said relay front-end module further comprises an analog-to-digital (A/D) converter coupled to said current-to-voltage converter circuit.

19. An electrical apparatus in accordance with claim 17 wherein said relay front-end module further comprises a step down transformer electrically coupled to a plurality of relay front-end module input terminations extending from said relay front-end module for receiving the analog input signal from said current transformer.

20. An electrical apparatus in accordance with claim 18 wherein said relay front-end module further comprises a fiber optic interface coupled to said A/D converter.

21. An electrical apparatus in accordance with claim 17 wherein said relay front-end module further comprises a fiber optic power supply coupled to said current-to-voltage converter and an A/D converter.

22. An electrical apparatus in accordance with claim 21 wherein said fiber optic power supply is coupled to a remote fiber optic power supply module.

23. An electrical apparatus in accordance with claim 17 wherein said protection module is coupled to a user interface module.

24. An instrument transformer in accordance with claim 23 wherein said user interface module comprises a data display.

25. An instrument transformer in accordance with claim 23 wherein said user interface module comprises a communications port.

26. An instrument transformer in accordance with claim 23 wherein said user interface module comprises an integral keypad.

27. An electrical apparatus in accordance with claim 17 wherein said current transformer and relay front-end module are integrally formed.
